(19) United States
(12) Patent Application Publication
(10) Pub. No.: US 2026/0211300 A1
(43) Pub. Date: Jul. 23, 2026

(54) CAMERA MODULE

(71) Applicant: Samsung Electro-Mechanics Co., Ltd., Suwon-si (KR)

(72) Inventors: Jae Won JUNG, Suwon-si (KR); Dong Yeon SHIN, Suwon-si (KR); Ji Hwan CHOI, Suwon-si (KR)

(73) Assignee: Samsung Electro-Mechanics Co., Ltd., Suwon-si (KR)

(21) Appl. No.: 19/442,270

(22) Filed: Jan. 7, 2026

(30) Foreign Application Priority Data
Jan. 20, 2025 (KR) 10-2025-0008333
Oct. 13, 2025 (KR) 10-2025-0146515

(51) Int. Cl. G03B 17/12; G03B 17/17; G03B 30/00; H04N 23/54; H04N 23/55; H04N 23/57

(52) U.S. Cl. CPC G03B 17/12; G03B 17/17; G03B 30/00; H04N 23/54; H04N 23/55; H04N 23/57; G03B 2217/002

(57) ABSTRACT

A camera module includes a housing; and a lens carrier accommodated in the housing, the lens carrier having a lens barrel in which one or more lenses are mounted. The lens carrier includes a first plate overlapping the lens barrel and the housing in a first axis direction perpendicular to an optical axis. A material of the first plate and a portion of the housing, overlapping the first plate in the first axis direction, includes metal.

### CROSS-REFERENCE TO RELATED APPLICATIONS

This application claims the benefit under 35 USC 119(a) of Korean Patent Application Nos. 10-2025-0008333 filed on Jan. 20, 2025, and 10-2025-0146515 Oct. 13, 2025, in the Korean Intellectual Property Office, the entire disclosures of which are incorporated herein by reference for all purposes.

### BACKGROUND

### 1. Field

The present disclosure relates to a camera module.

### 2. Description of the Background

Mobile devices, such as smartphones, may include a camera module, which has been gradually more advanced by incorporating not only an autofocus (AF) function and optical image stabilization (OIS) but also a zoom function.

As camera modules gain more functions, structures thereof have tended to become more complex and sizes thereof have tended to increase. However, in line with the trend of miniaturizing mobile devices, various approaches have been explored to minimize the size of the camera module.

Recently, it has become possible to arrange a lens in a direction other than a thickness direction of the camera module by bending an optical path using a reflective member. Such a structure may reduce limitations on the number of lenses; however, the structure may cause an issue in which a diameter of the lens influences a thickness of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing; and a lens carrier accommodated in the housing, the lens carrier having a lens barrel in which one or more lenses are mounted. The lens carrier includes a first plate overlapping the lens barrel and the housing in a first axis direction perpendicular to an optical axis. A material of the first plate and a portion of the housing, overlapping the first plate in the first axis direction, includes metal.

The housing may include a first part and a second part having materials with different elastic moduli (Young's moduli) from each other. The second part may be a portion of a bottom surface of the housing, and may overlap the first plate in the first axis direction.

The first part may be a remaining portion of the bottom surface of the housing, and the bottom surface of the housing may have a step portion.

A thickness of the second part may be less than a thickness of the first part.

The lens carrier may include a lens mounting portion in which one or more lenses are disposed, wherein the lens mounting portion includes the first plate; a first support portion configured to support one side of the lens mounting portion; and a second support portion configured to support another side of the lens mounting portion. Materials of the first support portion and the second support portion may be different from the material of the first plate.

The lens mounting portion may further include a second plate bent and extending from the first plate in the first axis direction, the second plate being disposed between the first support portion and the second support portion.

The first plate and the second plate may further include a light-shielding layer disposed on a surface thereof.

The second plate may include an opening in an optical axis direction, and the opening may overlap the lens barrel in the optical axis direction.

The second plate may be disposed on an image side of the lens barrel.

The lens mounting portion may further include an extension portion extending from the first plate toward the first support portion and the second support portion, and the extension portion may be disposed within the first support portion and the second support portion.

In another general aspect, a camera module includes a housing; a reflective module accommodated in the housing, the reflective module including a reflective member; and a lens module accommodated in the housing, the lens module including one or more lenses. A material of a bottom surface of a space of the housing in which the reflective module is disposed and a material of a bottom surface of another space of the housing in which the lens module is disposed are different from each other. A thickness of the bottom surface of the space in which the lens module is disposed is less than a thickness of the bottom surface of the other space in which the reflective module is disposed.

The housing may include a first part that is plastic and a second part that includes metal. The bottom surface of the space in which the reflective module is disposed may be the first part, and the bottom surface of the space in which the lens module is disposed may be the second part.

The lens module may include a first lens carrier in which a lens barrel is disposed, the first lens carrier being configured to move in an optical axis direction; and a second lens carrier in which a lens barrel is disposed, the second lens carrier being configured to move independently of the first lens carrier in the optical axis direction. Either one or both of the first lens carrier and the second lens carrier include a first plate overlapping the lens barrel in a first axis direction perpendicular to an optical axis, and the first plate includes a material including metal.

The first lens carrier and the second lens carrier may include a lens mounting portion including the first plate, and a plurality of support portions configured to support different sides of the lens mounting portion. A material of the plurality of support portions may be different from a material of the first plate.

The camera module may further include a second plate bent and extending from the first plate to overlap the lens barrel in the optical axis direction.

The first plate and the second plate may further include a light-shielding layer disposed on a surface thereof.

The camera module may further include an extension portion extending from the first plate toward the plurality of support portions. The extension portion may be disposed within the plurality of support portions.

Other features and aspects will be apparent from the following detailed description, the drawings, and the claims.

### BRIEF DESCRIPTION OF DRAWINGS

FIG. 1 is a perspective view of a portable electronic device in which a camera module is mounted according to an example embodiment of the present disclosure.

FIG. 2 is a perspective view of a camera module according to an example embodiment of the present disclosure.

FIG. 3A is a cross-sectional view taken along line I-I′ of FIG. 2, and FIG. 3B is a cross-sectional view taken along line II-II′ of FIG. 2.

FIG. 4 is a schematic exploded perspective view of a camera module according to an example embodiment of the present disclosure.

FIG. 5 is a perspective view of a reflective module according to an example embodiment of the present disclosure.

FIG. 6 is a perspective view of a housing according to an example embodiment of the present disclosure.

FIG. 7 is a cross-sectional view taken along line III-III′ of FIG. 6.

FIG. 8 is a perspective view of a lens module according to an example embodiment of the present disclosure.

FIG. 9 is an exploded perspective view of a lens module according to an example embodiment of the present disclosure.

FIG. 10 is a perspective view of a second lens carrier according to an example embodiment of the present disclosure.

FIG. 11 is a cross-sectional view taken along line IV-IV′ of FIG. 8.

FIG. 12 is a view of a lens module in an optical axis direction according to an example embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

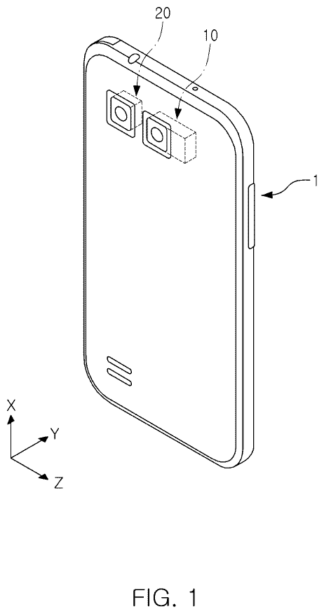

FIG. 1 is a perspective view of a portable electronic device in which a camera module is mounted according to an example embodiment of the present disclosure.

For example, as illustrated in FIG. 1, a portable electronic device 1 may be a smartphone.

One or more camera modules may be mounted in the portable electronic device 1. The one or more camera modules may include a first camera module 10 and a second camera module 20 having different fields of view. For example, the first camera module 10 may be a telephoto camera having a relatively narrow field of view, and the second camera module 20 may be a wide-angle camera having a relatively wide field of view.

The camera module according to an example embodiment of the present disclosure may be the first camera module 10.

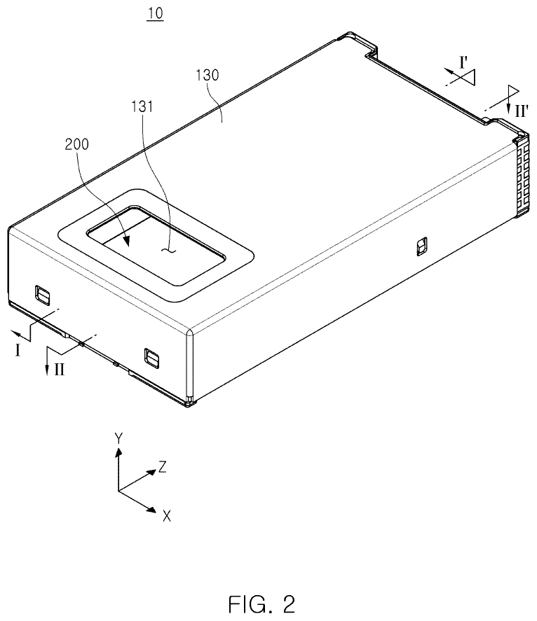

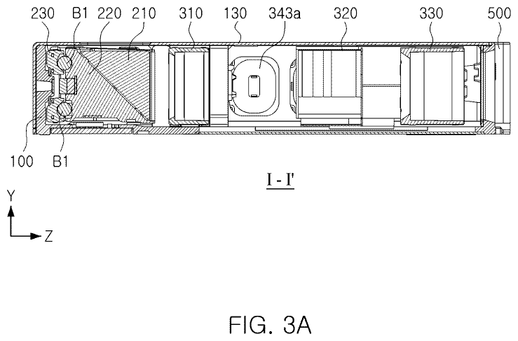

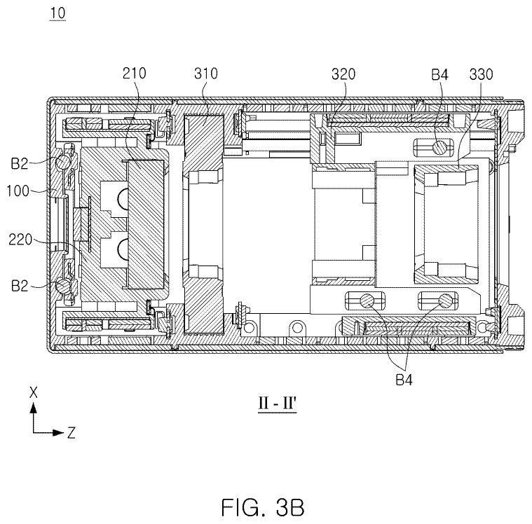

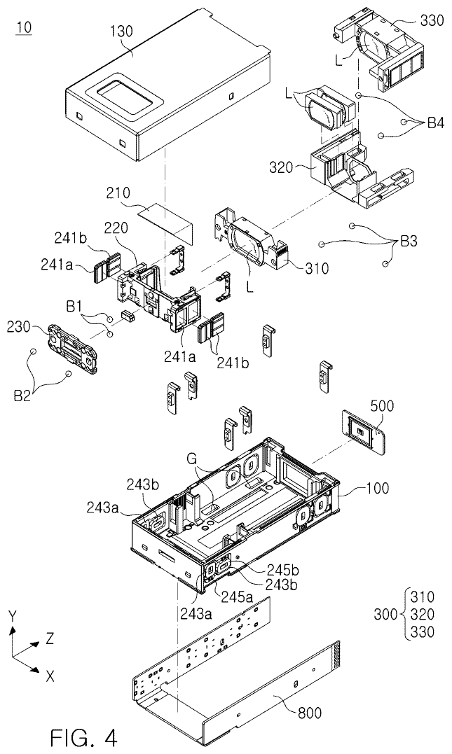

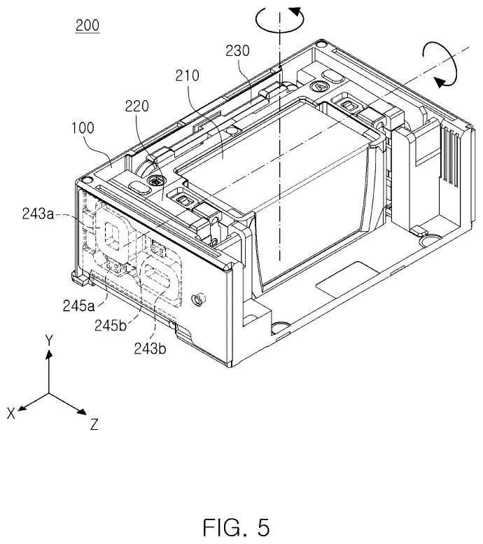

FIG. 2 is a perspective view of a camera module according to an example embodiment of the present disclosure. FIG. 3A is a cross-sectional view taken along line I-I′ of FIG. 2, and FIG. 3B is a cross-sectional view taken along line II-II′ of FIG. 2. FIG. 4 is a schematic exploded perspective view of a camera module according to an example embodiment of the present disclosure.

Referring to FIG. 2, the camera module 10 according to an example embodiment of the present disclosure may have a substantially rectangular parallelepiped shape.

In FIG. 2, a Z-direction may correspond to a length direction of the camera module 10, an X-direction may correspond to a width direction of the camera module 10, and a Y-direction may correspond to a thickness direction of the camera module 10.

The camera module 10 may be mounted on the portable electronic device 1 such that the thickness direction thereof corresponds to a thickness direction of the portable electronic device 1 illustrated in FIG. 1.

The camera module 10 may include a reflective member 210 configured to change a path of light. Light reflected from an external subject may be incident on the reflective member 210, and the reflective member 210 may reflect light, incident in a thickness direction of the camera module 10, in the length direction of the camera module 10.

A plurality of lenses L may be disposed in the camera module 10 in the length direction (hereinafter, referred to as an optical axis direction). That is, a plurality of lenses L may be disposed in a direction other than the thickness direction of the portable electronic device 1, such that the camera module 10 may include a relatively large number of lenses, and may secure a sufficient stroke when implementing an autofocus (AF) function and a zoom function.

According to an example embodiment, the camera module 10 may include a housing 100, a reflective module 200 including a reflective member 210, a lens module 300 including a plurality of lenses L, and an image sensor module 500 including an image sensor.

The housing 100 may form an exterior of the camera module 10. For example, the housing 100 may have a substantially rectangular parallelepiped shape in the same manner as the camera module 10.

In addition, the housing 100 may be a member in which components including the reflective module 200, the lens module 300, and the image sensor module 500 are accommodated and disposed. Accordingly, the housing 100 may be formed of a plastic material (hereinafter, referred to as a high-strength polymer material) having high strength to have rigidity, and may have an internal space.

A case 130 may be coupled to the housing 100. The case 130 may be coupled to the housing 100 to cover the internal space of the housing 100.

An opening 131 may be formed in the case 130 to allow incidence of light. External light may be incident on the reflective member 210 through the opening 131.

The reflective module 200 may include a reflective member 210, a reflective member holder 220, and a rotation guide 230.

The reflective member 210 may change a travel direction of incident light to face the lens module 300. In an example embodiment, the reflective member 210 may be a prism. However, the reflective member 210 may be replaced with and implemented as a mirror or the like.

The reflective member 210 may be mounted on the reflective member holder 220. A reflective surface of the reflective member 210 may be placed on a mounting surface of the reflective member holder 220, and two side surfaces of the reflective member 210 may be respectively supported by two side surfaces of the reflective member holder 220 extending in the optical axis direction (Z-axis direction) from both sides of the mounting surface. When the reflective member holder 220 has the mounting surface and the two side surfaces, the reflective member holder 220 may be implemented in other forms different from the form illustrated in the drawings.

The reflective member holder 220 may be supported by the housing 100 via the rotation guide 230. That is, the rotation guide 230 may be disposed between the reflective member holder 220 and the housing 100.

The camera module 10 may perform optical image stabilization during capturing of an image by rotating the reflective member 210. The reflective member 210 may rotate using two axes, perpendicular to an optical axis (Z-axis), as a rotation axis.

The reflective member 210 may rotate about a first axis (Y-axis) in a state of being mounted on the reflective member holder 220. Such rotation may be rotation relative to the rotation guide 230. Referring to FIG. 3A, a first ball member B1 may be disposed between the reflective member holder 220 and the rotation guide 230. The first ball member B1 may be spaced apart from each other in a first axis direction (Y-axis direction) to form the first axis (Y-axis), and may support rotation of the reflective member 210 about the first axis (Y-axis).

In addition, the reflective member 210 may rotate about a second axis (X-axis), perpendicular to the first axis (Y-axis), together with the rotation guide 230. Such rotation may be rotation relative to the housing 100. Referring to FIG. 3B, a second ball member B2 may be disposed between the rotation guide 230 and the housing 100. The second ball member B2 may be spaced apart from each other in a second axis direction (X-axis direction) to form the second axis (X-axis), and may support rotation of the reflective member 210 about the second axis (X-axis).

The reflective member holder 220 may be pulled toward the rotation guide 230 with the first ball member B1 interposed therebetween, and the rotation guide 230 may be pulled toward the housing 100 with the second ball member B2 interposed therebetween. Referring to FIG. 4, both the reflective member holder 220 and the rotation guide 230 may be pulled toward a counterpart member in the optical axis direction (Z-axis direction).

To this end, the reflective module 200 may include a pair of pulling members. In an example embodiment, the pair of pulling members may be disposed to oppose each other in the optical axis direction (Z-axis direction) to generate magnetic attraction in the optical axis direction (Z-axis direction). The pair of pulling members may be respectively disposed in the reflection member holder 220 and the housing 100.

A direction in which the reflective member holder 220 is pulled toward the rotation guide 230 and a direction in which the rotation guide 230 is pulled toward the housing 100 may vary according to positions of the first ball member B1 and the second ball member B2. The positions of the first ball member B1 and the second ball member B2 are not limited to the positions illustrated in the drawings.

A hemispherical protrusion may be provided in at least one of the reflective member holder 220, the rotation guide 230, and the housing 100 in place of the first ball member B1 and the second ball member B2. In this case, except that the first ball member B1 and the second ball member B2 are replaced with hemispherical protrusions, the above description may be applied in the same manner.

The reflective module 200 may include a driving unit generating driving force for rotating the reflective member 210. The driving unit may include a magnet and a coil, and electromagnetic force generated by the driving force may be driving force.

For example, magnets 241a and 241b may be disposed in the reflective member holder 220, and the coils 243a and 243b may be disposed in the housing 100 to oppose the magnets 241a and 241b. In addition, position sensors 245a and 245b may be disposed in the housing 100 to oppose the magnets 241a and 241b. The coils 243a and 243b and the position sensors 245a and 245b may be mounted on a substrate 800 disposed on a side surface of the housing 100.

The lens module 300 may include a plurality of lenses L and a plurality of lens carriers.

In an example embodiment, the lens module 300 may include three lens carriers (hereinafter, a first lens carrier 310, a second lens carrier 320, and a third lens carrier 330). One or more lenses may be mounted on the first lens carrier 310, the second lens carrier 320, and the third lens carrier 330, respectively.

The plurality of lenses L and the plurality of lens carriers 310, 320, and 330 may be disposed in the optical axis direction (Z-axis direction). That is, the plurality of lenses L may be mounted on the plurality of lens carriers 310, 320, and 330 in an upright state.

According to an example embodiment, in order to minimize an increase in thickness of the camera module 10 caused by a diameter of the plurality of lenses L, the plurality of lenses L may include a D-cut lens.

The D-cut lens may include a pair of arc portions and a pair of straight portions, opposing each other. In the D-cut lens, the pair of arc portions may oppose each other in width direction of the camera module 10, and the pair of straight portions may oppose each other in a height direction of the camera module 10. A distance from a center of the D-cut lens to the pair of straight portions may be shorter than a distance from a center of the D-cut lens to the pair of arc portions, such that the thickness of the camera module 10 may be reduced using the D-cut lens.

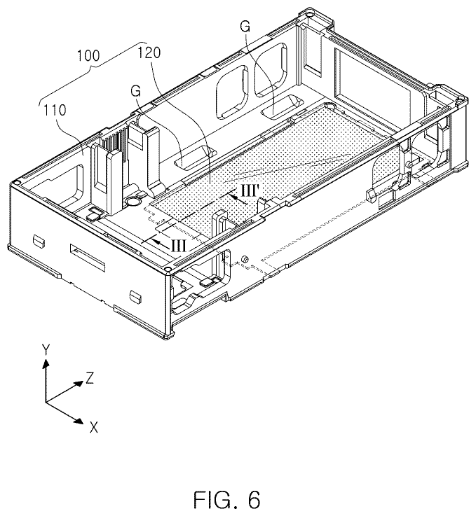

In addition, according to an example embodiment of the present disclosure, in order to reduce the thickness of the camera module 10 the housing 100 may be provided in the form illustrated in FIG. 6 or the like.

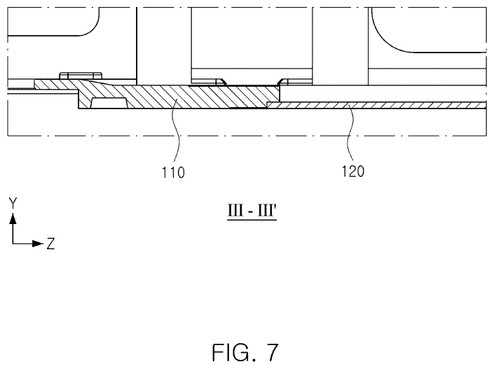

FIG. 6 is a perspective view of a housing according to an example embodiment of the present disclosure. FIG. 7 is a cross-sectional view taken along line III-III′ of FIG. 6.

Referring to FIG. 6, the housing 100 may have a rectangular parallelepiped shape with an open upper portion, and may include a bottom surface and four side surfaces. The internal space of the housing 100 may be defined by the bottom surface and the four side surfaces.

As described above, the housing 100 may be formed of a high-strength polymer material, and a portion of the bottom surface may be formed of a material including metal. Specifically, the internal space of the housing 100 may be divided into a space in which the reflective module 200 is disposed and a space in which the lens module 300 is disposed, and a portion of the bottom surface, defining the space in which the lens module 300 is disposed, may be formed of a material including metal.

In other words, the housing 100 may include a first part 110 formed of a high-strength polymer material, and a second part 120 formed of a material different from that of the first part 110, for example, a material including metal. The second part 120 may be in the form of a thin plate, and may form a portion of the bottom surface of the housing 100. The first part 110 may be a remaining portion excluding the second part 120.

The first part 110 and the second part 120 may be integrally formed. For example, the housing 100 may be manufactured through an insert injection method in which a liquid polymer is injected into a mold after the second part 120 is disposed within the mold. As the liquid polymer is cured, the second part 120 may be firmly fixed to the first part 110.

The second part 120 may be formed of a material including metal, such that the second part 120 may have strength higher than that of the first part 110 formed of a high-strength polymer material having the same thickness. Accordingly, the first part 110 and the second part 120 of the housing 100 may have different thicknesses. For example, the second part 120 may be manufactured to have a thickness less than that of the first part 110.

In an example embodiment, the first part 110 and the second part 120 may form a portion of the bottom surface of the housing 100, such that the bottom surface of the housing 100 may have a step portion. For example, the first part 110 may form a bottom surface of a space in which the reflective module 200 is disposed, and the second part 120 may form a bottom surface of a space in which the lens module 300 is disposed. Accordingly, a thickness of the bottom surface of the space in which the lens module 300 is disposed may be less than that of the bottom surface of the space in which the reflective module 200 is disposed.

According to an example embodiment, the bottom surface of the space in which the lens module 300 is disposed may have a relatively small thickness, thereby reducing a thickness of the camera module 10. In addition, a lens having a relatively large diameter may be used without increasing the thickness of the camera module 10, thereby securing performance of the camera module 10.

Subsequently, the lens module 300 will be described again.

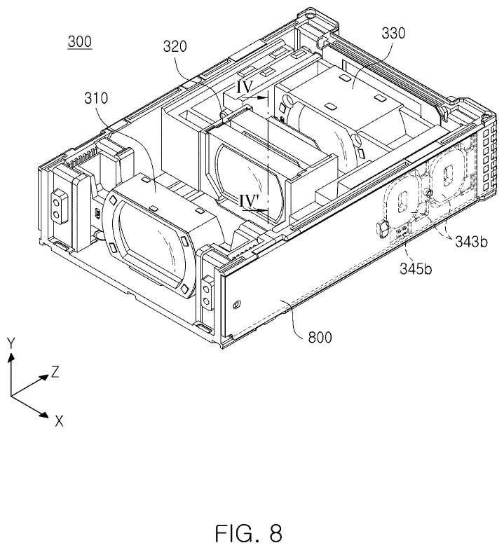

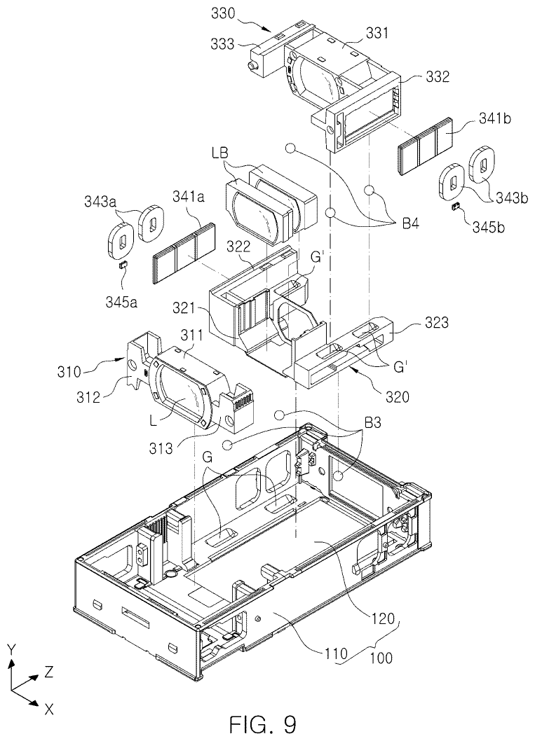

FIG. 8 is a perspective view of a lens module according to an example embodiment of the present disclosure. FIG. 9 is an exploded perspective view of a lens module according to an example embodiment of the present disclosure.

The first lens carrier 310 may be fixedly disposed in the housing 100. The second lens carrier 320 and the third lens carrier 330 may be movably disposed in the housing 100.

The camera module 10 may move the second lens carrier 320 and the third lens carrier 330 to adjust a focal point and perform zoom. The second lens carrier 320 and the third lens carrier 330 may move in the optical axis direction (Z-axis direction). The second lens carrier 320 and the third lens carrier 330 may move independently.

The first lens carrier 310 may have a shape symmetrical with respect to the optical axis (Z-axis). The first lens carrier 310 may include a lens mounting portion 311 on which one or more lenses are mounted, and a plurality of support portions 312 and 313 supporting one side and the other side of the lens mounting portion 311. The first lens carrier 310 may be fixed to the housing 100 through the plurality of support portions 312 and 313. The shape of the first lens carrier 310 is not limited to the shape illustrated in the drawings.

The second lens carrier 320 and the third lens carrier 330 may have a shape asymmetrical with respect to the optical axis (Z-axis). Each of the second lens carrier 320 and the third lens carrier 330 may include lens mounting portions 321 and 331 on which one or more lenses are mounted, and a plurality of support portions 322 and 323, 332, and 333 supporting one side and the other side of the lens mounting portions 321 and 331.

A maximum diameter of the one or more lenses mounted on the second lens carrier 320 may be greater than a maximum diameter of the one or more lenses mounted on the third lens carrier 330. For example, a diameter of one or more lenses mounted on the second lens carrier 320 may be generally greater than a diameter of one or more lenses mounted on the third lens carrier 330.

The second lens carrier 320 may be movably supported by the housing 100 through a plurality of support portions 322 and 323. The third lens carrier 330 may be movably supported by the second lens carrier 320 through the plurality of support portions 332 and 333.

The second lens carrier 320 may include a first support portion 322 supporting one side of the lens mounting portion 321, and a second support portion 323 supporting the other side of the lens mounting portion 321. In an example embodiment, a length of the first support portion 322 in the first-axis direction (Y-axis direction) may be greater than a length of the second support portion 323 in the first-axis direction (Y-axis direction). Accordingly, the second lens carrier 320 may have a shape asymmetrical with respect to the optical axis (Z-axis).

The third lens carrier 330 may include a third support portion 332 supporting one side of the lens mounting portion 331, and a fourth support portion 333 supporting the other side of the lens mounting portion 331. In an example embodiment, a length of the third support portion 332 in the optical axis direction (Z-axis direction) may be greater than a length of the fourth support portion 333 in the optical axis direction (Z-axis direction). Accordingly, the third lens carrier 330 may have a shape asymmetrical with respect to the optical axis (Z-axis).

As long as the second lens carrier 320 and the third lens carrier 330 may be provided to be movable independently of each other, a shape and structure of each of the second lens carrier 320 and the third lens carrier 330 are not limited to the shape and structure illustrated in the drawings.

A third ball member B3 may be disposed between the second lens carrier 320 and the housing 100. The third ball member B3 may include three or more ball members.

Some ball members B3, among the third ball members B3, may be disposed between the first support portion 322 and the housing 100, and remaining ball members may be disposed between the second support portion 323 and the housing 100.

The third ball member B3 may be disposed between a guide groove G formed in the second lens carrier 320 and a guide groove G formed in the housing 100 to support movement of the second lens carrier 320 in the optical axis direction (Z-axis direction). For example, a guide groove G in which the third ball member B3 is disposed may have a length in the optical axis direction (Z-axis direction), and the third ball member B3 may perform rolling motion along the guide groove G.

The third lens carrier 330 may be supported by the second lens carrier 320, such that the third lens carrier 330 may move in the optical axis direction (Z-axis direction), together with the second lens carrier 320.

A fourth ball member B4 may be disposed between the third lens carrier 330 and the second lens carrier 320. The fourth ball member B4 may include three or more ball members.

Some ball members B4, among the fourth ball members B4, may be disposed between the first support portion 322 and the fourth support portion 333, and remaining ball members may be disposed between the second support portion 323 and the third support portion 332.

The fourth ball member B4 may be disposed between a guide groove G′ formed in the second lens carrier 320 and a guide groove G′ formed in the third lens carrier 330 to support movement of the third lens carrier 330 in the optical axis direction (Z-axis direction). For example, a guide groove G′ in which the fourth ball member B4 is disposed may have a length in the optical axis direction (Z-axis direction), and the fourth ball member B4 may perform rolling motion along the guide groove G. The movement of the third lens carrier 330 may be movement relative to the second lens carrier 320.

The second lens carrier 320 may be pulled toward the housing 100 with the third ball member B3 interposed therebetween, and the third lens carrier 330 may be pulled toward the second lens carrier 320 with the fourth ball member B4 interposed therebetween. Referring to FIG. 9, both the second lens carrier 320 and the third lens carrier 330 may be pulled toward a counterpart member in the first axis direction (Y-axis direction).

To this end, the lens module 300 may include a pair of pulling members. In an example embodiment, the pair of pulling members may be disposed to oppose each other in the first axis direction (Y-axis direction) to generate magnetic attraction in the first axis direction (Y-axis direction).

One pulling member, among the pair of pulling members, may be disposed on a bottom surface of the second lens carrier 320, and the other pulling member may be disposed in the housing 100. For example, a pulling magnet may be disposed in the second carrier 320, a pulling yoke may be disposed in the housing 100, and the second part 120 may serve as a pulling yoke.

The lens module 300 may include a driving unit generating driving force for moving the second lens carrier 320 and the third lens carrier 330. The driving unit may include a magnet and a coil, and electromagnetic force, generated by the driving force, may be driving force.

Magnets 341a and 341b may be disposed in the second carrier 320 and the third carrier 330, and the coils 343a and 343b may be disposed in the housing 100 to oppose the magnets 341a and 341b. In addition, position sensors 345a and 345b may be disposed in the housing 100 to oppose the magnets 341a and 341b. The coils 343a and 343b and the position sensors 345a and 345b may be provided in the same number as or in greater numbers than the magnets 341a and 341b. Accordingly, the magnets 341a and 341b may oppose one or more coils 343a and 343b and one or more magnets 345a and 345b, respectively. The coils 343a and 343b and the position sensors 345a and 345b may be mounted on the substrate 800 disposed on the side surface of the housing 100.

More specifically, the magnets 341a and 341b may include a first magnet 341a disposed in the second lens carrier 320, and a second magnet 341b disposed in the third lens carrier 330.

The first magnet 341a may be disposed on the first support portion 322 of the second lens carrier 320, and the second magnet 341b may be disposed on the third support portion 332 of the third lens carrier 330. The first support portion 322 and the third support portion 332 may be disposed to be opposite to each other with respect to the optical axis (Z-axis).

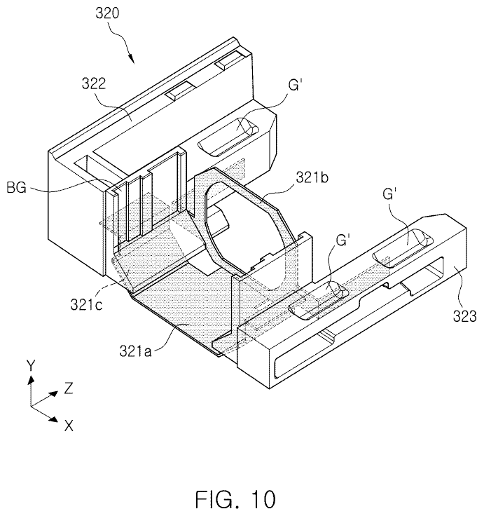

According to an example embodiment of the present disclosure, in order to reduce the thickness of the camera module 10, the second lens carrier 320 may be provided in the form illustrated in FIG. 10.

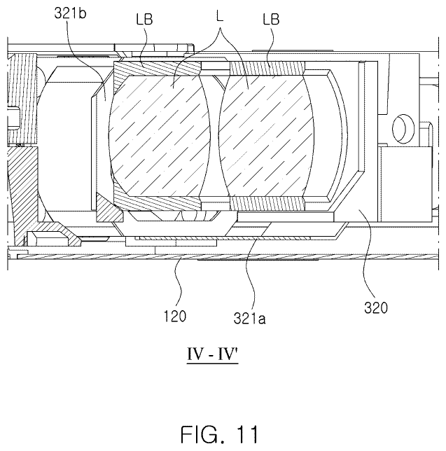

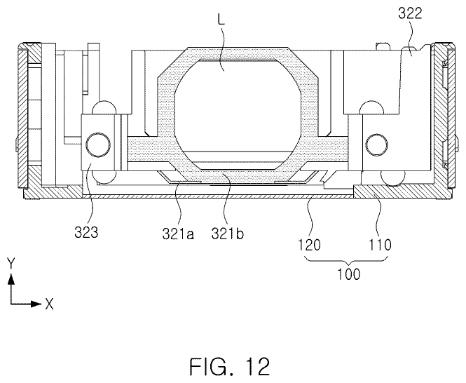

FIG. 10 is a perspective view of a second lens carrier according to an example embodiment of the present disclosure. FIG. 11 is a cross-sectional view taken along line IV-IV′ of FIG. 8. FIG. 12 is a view of a lens module in an optical axis direction according to an example embodiment of the present disclosure.

Referring to FIG. 10, the second lens carrier 320 may be formed such that the lens mounting portion 321 and the plurality of support portions 322 and 323 are formed of different materials. A portion of the lens mounting portion 321 may be formed of a material including metal, and the plurality of support portions 322 and 323 may be formed of a high-strength polymer material.

More specifically, the lens mounting portion 321 may be formed such that at least portion of a bottom surface thereof (hereinafter, a first plate 321a) is formed of a material including metal. As described above, a material including metal may have strength higher than that of a high-strength polymer material, and thus may be manufactured to have a small thickness.

The first plate 321a may be a portion overlapping the second part 120 of the housing 100 in the thickness direction of the camera module 10. In addition, at the same time, the first plate 321a may be a portion overlapping a lens disposed in the lens mounting portion 321 in the thickness direction of the camera module 10.

According to an example embodiment, in a state in which the second lens carrier 320 is disposed in the housing 100, portions of the second lens carrier 320 and the housing 100, overlapping in the thickness direction of the camera module 10, may be all formed of a material including metal, thereby further reducing a thickness of the camera module 10.

The second lens carrier 320 may be formed as a single component. For example, the lens mounting portion 321 and the plurality of support portions 322 and 323 may be integrally formed through an insert injection method.

The lens mounting portion 321 may include an extension portion 321c extending from the first plate 321a toward the plurality of support portions 322 and 323. While the first plate 321a is exposed externally, the extension portion 321c may not be exposed externally. The extension portion 321c may serve to firmly fix the first plate 321a or the like.

One or more lenses L may be disposed in the lens mounting portion 321. For example, the one or more lenses L may be individually or together mounted in a lens barrel LB and fixed to the lens mounting portion 321. One or more lens barrels LB may be disposed in the lens mounting portion 321. The lens mounting portion 321 may include a coupling groove BG to which a side surface of the lens barrel LB is coupled and fixed. A portion of the lens mounting portion 321 including the coupling groove BG may be formed of a high-strength polymer material in the same manner as the plurality of support portions 322 and 323.

The second lens carrier 320 may further include a second plate 321b extending in a vertical direction from the first plate 321a. The second plate 321b may be bent and extend from the first plate 321a in a first-axis direction (Y-axis direction). The second plate 321b may be a portion extending from the first plate 321a, and thus may be formed of a material the same as that of the first plate 321a.

The second plate 321b may be disposed with respect to the lens barrel LB in the optical axis direction (Z-axis direction). An opening that is open in the optical axis direction (Z-axis direction) may be formed in the second plate 321b. The opening may overlap the lenses mounted in the lens barrel LB in the optical axis direction (Z-axis direction). The second plate 321b may be disposed on an image side of the lens barrel LB, and light, emitted from the lenses mounted in the lens barrel LB, may pass through the opening of the second plate 321b.

In another example embodiment, the third lens carrier 330 may also be formed such that the lens mounting portion 331 and the plurality of support portions 332, 333 are formed of different materials in the same manner as the second lens carrier 320. In this case, the above-described description of the second lens carrier 320 may be applied to the third lens carrier 330 in the same manner.

In an example embodiment, the housing 100 and the lens carriers 310, 320, and 330 may be formed of a polymer material having high strength, and for example, may be formed of a polycarbonate (PC) material. In addition, portions of the housing 100 and the second lens carrier 320 may be formed of a material including metal, and for example, may be formed of a stainless steel (SUS) material. The second part 120 of the housing 100 and the first plate 321a, the second plate 321b, and the extension portion 321c of the second lens carrier 320 may be formed of a stainless steel (SUS) material.

The stainless steel (SUS) material has an elastic modulus E (Young's modulus) higher than that of a polycarbonate (PC) material, thereby securing structural stability and reliability even with a relatively small thickness. Accordingly, a portion formed of a stainless steel (SUS) material may be manufactured to have a thickness less than that of a portion formed of a polycarbonate (PC) material.

However, the above-described high-strength polymer material and material including metal are merely one example, and may be replaced with other materials having similar properties.

The material including metal of the housing 100 and the second lens carrier 320 may undergo a post-treatment process to serve to reduce flare. For example, the second part 120 of the housing 100 and the first and second plates 321a and 321b of the second lens carrier 320 may be post-treated to include a light-shielding layer. In an example, the stainless steel (SUS) material may include a black-coated light-shielding layer. In another example, depending on a type of the material including metal, an oxide film layer may serve as the light-shielding layer.

Light incident on the camera module 10 may be incident on the image sensor module 500 after passing through the lens module 300.

The image sensor may be disposed such that an imaging plane of the image sensor faces the lens module 300, and may convert light passing through the lens module 300 into an electrical signal.

The image sensor module 500 may further include a printed circuit board on which the image sensor is disposed, and an optical filter portion disposed in front of the image sensor. For example, the optical filter portion may include an infrared-cut filter and a sub-housing in which the infrared-cut filter is mounted.

An aspect of one or more embodiments of the present disclosure is to reduce a thickness of a camera module, and furthermore, to maintain structural reliability while reducing a thickness of a camera module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing; and
a lens carrier accommodated in the housing, the lens carrier having a lens barrel in which one or more lenses are mounted,
wherein the lens carrier comprises a first plate overlapping the lens barrel and the housing in a first axis direction perpendicular to an optical axis, and
wherein a material of the first plate and a portion of the housing, overlapping the first plate in the first axis direction, comprises metal.

2. The camera module of claim 1, wherein
the housing comprises a first part and a second part having materials with different elastic moduli (Young's moduli) from each other, and
the second part is a portion of a bottom surface of the housing, and overlaps the first plate in the first axis direction.

3. The camera module of claim 2, wherein the first part is a remaining portion of the bottom surface of the housing, and
wherein the bottom surface of the housing has a step portion.

4. The camera module of claim 3, wherein a thickness of the second part is less than a thickness of the first part.

5. The camera module of claim 1, wherein the lens carrier comprises:
a lens mounting portion in which one or more lenses are disposed, wherein the lens mounting portion comprises the first plate;
a first support portion configured to support one side of the lens mounting portion; and
a second support portion configured to support another side of the lens mounting portion, and
wherein materials of the first support portion and the second support portion are different from the material of the first plate.

6. The camera module of claim 5, wherein the lens mounting portion further comprises a second plate bent and extending from the first plate in the first axis direction, the second plate being disposed between the first support portion and the second support portion.

7. The camera module of claim 6, wherein
the second plate comprises an opening in an optical axis direction, and
the opening overlaps the lens barrel in the optical axis direction.

8. The camera module of claim 7, wherein the second plate is disposed on an image side of the lens barrel.

9. The camera module of claim 5, wherein the lens mounting portion further comprises an extension portion extending from the first plate toward the first support portion and the second support portion, and the extension portion is disposed within the first support portion and the second support portion.

10. A camera module comprising:
a housing;
a reflective module accommodated in the housing, the reflective module comprising a reflective member; and
a lens module accommodated in the housing, the lens module comprising one or more lenses,
wherein a material of a bottom surface of a space of the housing in which the reflective module is disposed and a material of a bottom surface of another space of the housing in which the lens module is disposed are different from each other, and
a thickness of the bottom surface of the space in which the lens module is disposed is less than a thickness of the bottom surface of the other space in which the reflective module is disposed.

11. The camera module of claim 10, wherein
the housing comprises a first part that is plastic and a second part that comprises metal, and
the bottom surface of the space in which the reflective module is disposed is the first part, and the bottom surface of the space in which the lens module is disposed is the second part.

12. The camera module of claim 10, wherein the lens module comprises:
a first lens carrier in which a lens barrel is disposed, the first lens carrier being configured to move in an optical axis direction; and
a second lens carrier in which a lens barrel is disposed, the second lens carrier being configured to move independently of the first lens carrier in the optical axis direction, and
wherein either one or both of the first lens carrier and the second lens carrier comprise a first plate overlapping the lens barrel in a first axis direction perpendicular to an optical axis, and the first plate comprises a material including metal.

13. The camera module of claim 12, wherein
the first lens carrier and the second lens carrier comprise a lens mounting portion comprising the first plate, and a plurality of support portions configured to support different sides of the lens mounting portion, and
a material of the plurality of support portions is different from a material of the first plate.

14. The camera module of claim 13, further comprising:
a second plate bent and extending from the first plate to overlap the lens barrel in the optical axis direction.

15. The camera module of claim 14, wherein the first plate and the second plate further comprise a light-shielding layer disposed on a surface thereof.

16. The camera module of claim 13, further comprising an extension portion extending from the first plate toward the plurality of support portions,
wherein the extension portion is disposed within the plurality of support portions.
